(19) United States
(12) Patent Application Publication
(10) Pub. No.: US 2017/0255339 A1
(43) Pub. Date: Sep. 7, 2017

(54) PRIMARY-CONNECTED DEVICE CONTROL FROM VEHICLE COMPUTING PLATFORMS AND SECONDARY-CONNECTED DEVICES

(71) Applicant: MYINE ELECTRONICS, INC., Ferndale, MI (US)

(72) Inventors: Joey Ray GROVER, Madison Heights, MI (US); Justin DICKOW, Royal Oak, MI (US); Scott SMEREKA, Warren, MI (US); Joel J. FISCHER, Royal Oak, MI (US); John BYRNE, Detroit, MI (US); Corey MAYLONE, Berkley, MI (US)

(21) Appl. No.: 15/063,044

(22) Filed: Mar. 7, 2016

(51) Int. Cl. G06F 3/0481; H04W 76/02; H04L 29/08; H04W 8/00

(52) U.S. Cl. CPC G06F 3/0481; H04W 8/005; H04W 76/023; H04L 67/12

(57) ABSTRACT

A mobile device may advertise an application human-machine interface (HMI) service responsive to connection to a computing platform of a vehicle as the primary mobile device. One or more secondary mobile devices may connect to the application HMI service of the primary mobile device. The primary mobile device may provide a user interface of a connected application executed by the primary mobile device to the computing platform and to the at least one secondary mobile device, each secondary device executing the connected application.

### TECHNICAL FIELD

Aspects of the disclosure generally relate to control of applications of primary-connected devices from secondary-connected devices.

### BACKGROUND

To pair a phone or other mobile device with a vehicle, the user may enable BLUETOOTH on the device to be paired, and select from the vehicle computing system to begin the pairing process. To complete the pairing, the vehicle may display a personal identification number (PIN), and the user may enter the PIN into the device to be paired to the vehicle. Upon successful entry of the PIN, the vehicle computing system may display a message indicating that the mobile device is paired to the vehicle. Once paired, the vehicle and mobile device may automatically connect.

SmartDeviceLink (SDL) is a standard set of protocols and messages that connect applications on a smartphone to a vehicle head unit. This messaging enables a consumer to interact with their application using common in-vehicle interfaces such as a touch screen display, embedded voice recognition, steering wheel controls and various vehicle knobs and buttons. There are three main components that make up the SDL ecosystem. The core component is the software which vehicle manufacturers (OEMs) implement in their vehicle head units. Integrating this component into their head unit and HMI based on a set of guidelines and templates enables access to various smartphone applications. The optional SDL Server can be used by vehicle OEMs to update application policies and gather usage information for connected applications. The iOS and Android libraries are implemented by app developers into their applications to enable command and control via the connected head unit.

### SUMMARY

In a first illustrative embodiment, a system includes a primary mobile device programmed to advertise an application human-machine interface (HMI) service responsive to connection to a computing platform of a vehicle as the primary mobile device, connect to at least one secondary mobile device, and provide a user interface of a connected application executed by the primary mobile device to the computing platform and to the at least one secondary mobile device, each secondary mobile device executing the connected application.

In a second illustrative embodiment, a system includes a plurality of mobile devices, each executing a connected application, one of the mobile devices connected to a vehicle computing platform as a primary device, each other mobile device connected to an application human-machine interface (HMI) service executed by the primary device, the primary device programmed to send message flows to the computing platform to provide a primary user interface and to each other mobile device to provide secondary user interfaces.

In a third illustrative embodiment, a non-transitory computer-readable medium, comprising instructions that, when executed by a processor of a mobile device, cause the mobile device to advertise an application human-machine interface (HMI) service responsive to connection to a computing platform of a vehicle as the primary mobile device; connect to at least one secondary mobile device; and provide message flows via the HMI service of a connected application executed by the primary mobile device to the computing platform and to the at least one secondary mobile device, to cause the computing platform and the at least one secondary mobile device to render a user interface of the connected application.

### BRIEF DESCRIPTION OF THE DRAWINGS

FIG. 1 illustrates an example diagram of a system that may be used to provide telematics services to a vehicle;

FIG. 2 illustrates an example diagram of the system configured for application control of a primary-connected device from one or more secondary-connected devices;

FIG. 3 illustrates an example diagram of user interface messaging between the primary-connected device, the secondary-connected devices, and the vehicle computing platform;

FIG. 4 illustrates an example process for a mobile device acting as a primary-connected device in communication with the computing platform; and

FIG. 5 illustrates an example process for a mobile device acting as a secondary-connected device in communication with the primary-connected device.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Multiple devices may be paired to a vehicle, but in many cases only one device may be connected to the vehicle as the driver device or primary device. Various approaches may be used by the vehicle to choose which detected device is to be connected to the vehicle as the primary device. In an example, the user may specify in vehicle preferences for a particular mobile device to be preferred for connection as the primary device, even if other paired devices are available.

The device connected with the vehicle as the primary device may be provided with additional functionality by the vehicle computing system. For instance, the connected device may be provided with access to audio functionality of the vehicle, such as to receive audio from a vehicle microphone or to playback audio through the vehicle sound system. As another example, the primary device may execute applications controlled using a display of the head unit.

When connected to the vehicle computing platform, the primary device's input screen may be disabled. However, the driver and/or passengers of the vehicle may be able to control the applications via the head unit display. Passengers who are unable to reach the head unit display, however, may be unable to view or control the applications.

An improved system may allow the primary device (e.g., a driver's mobile phone) connected to a vehicle computing system to communicate with the mobile devices of other users within the vehicle. The primary device may advertise an application human-machine interface (HMI) service, and other mobile devices within the vehicle may identify the application HMI service and connect to the primary device. When devices are connected to the primary device, the primary device may be configured to route messages to any of the connected devices, including the vehicle computing system. Each connected device may send messages directly to the primary device to control connected applications executed by the primary device. For instance, a back seat passenger having a mobile device may connect to the primary device using the same communication protocol as the primary device uses to connect to the vehicle computing system. Thus, the back seat passenger's mobile device may allow the back seat passenger to control the one or more applications being executed at the primary device.

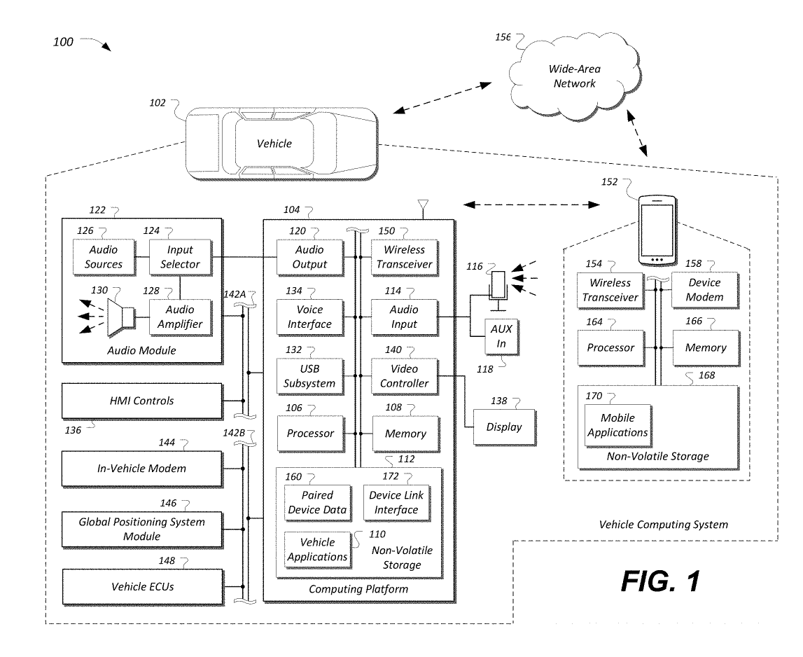

FIG. 1 illustrates an example diagram of a system 100 that may be used to provide telematics services to a vehicle 102. The vehicle 102 may include various types of passenger vehicle, such as crossover utility vehicle (CUV), sport utility vehicle (SUV), truck, recreational vehicle (RV), boat, plane or other mobile machine for transporting people or goods. Telematics services may include, as some non-limiting possibilities, navigation, turn-by-turn directions, vehicle health reports, local business search, accident reporting, and hands-free calling. In an example, the system 100 may include the SYNC system manufactured by The Ford Motor Company of Dearborn, Mich. It should be noted that the illustrated system 100 is merely an example, and more, fewer, and/or differently located elements may be used.

The computing platform 104 may include one or more processors 106 connected with both a memory 108 and a computer-readable storage medium 112 and configured to perform instructions, commands and other routines in support of the processes described herein. For instance, the computing platform 104 may be configured to execute instructions of vehicle applications 110 to provide features such as navigation, accident reporting, satellite radio decoding, and hands-free calling. Such instructions and other data may be maintained in a non-volatile manner using a variety of types of computer-readable storage medium 112. The computer-readable medium 112 (also referred to as a processor-readable medium or storage) includes any non-transitory (e.g., tangible) medium that participates in providing instructions or other data that may be read by the processor 106 of the computing platform 104. Computer-executable instructions may be compiled or interpreted from computer programs created using a variety of programming languages and/or technologies, including, without limitation, and either alone or in combination, Java, C, C++, C#, Objective C, Fortran, Pascal, Java Script, Python, Perl, and PL/SQL.

The computing platform 104 may be provided with various features allowing the vehicle occupants to interface with the computing platform 104. For example, the computing platform 104 may include an audio input 114 configured to receive spoken commands from vehicle occupants through a connected microphone 116, and auxiliary audio input 118 configured to receive audio signals from connected devices. The auxiliary audio input 118 may be a wired jack, such as a stereo input, or a wireless input, such as a BLUETOOTH audio connection. In some examples, the audio input 114 may be configure to provide audio processing capabilities, such as pre-amplification of low-level signals, and conversion of analog inputs into digital data for processing by the processor 106.

The computing platform 104 may also provide one or more audio outputs 120 to an input of the audio playback functionality of the audio module 122. In other examples, the computing platform 104 may provide audio output to the occupants through use of one or more dedicated speakers (not illustrated). The audio module 122 may include an input selector 124 configured to provide audio content from a selected audio source 126 to an audio amplifier 128 for playback through vehicle speakers 130. The audio sources 126 may include, as some examples, decoded amplitude modulated (AM) or frequency modulated (FM) radio signals, and compact disc (CD) or digital versatile disk (DVD) audio playback. The audio sources 126 may also include audio received from the computing platform 104, such as audio content generated by the computing platform 104, audio content decoded from flash memory drives connected to a universal serial bus (USB) subsystem 132 of the computing platform 104, and audio content passed through the computing platform 104 from the auxiliary audio input 118.

The computing platform 104 may utilize a voice interface 134 to provide a hands-free interface to the computing platform 104. The voice interface 134 may support speech recognition from audio received via the microphone 116 according to a grammar of available commands, and voice prompt generation for output via the audio module 122. In some cases, the system may be configured to temporarily mute, fade, or otherwise override the audio source specified by the input selector 124 when an audio prompt is ready for presentation by the computing platform 104 and another audio source 126 is selected for playback.

The computing platform 104 may also receive input from human-machine interface (HMI) controls 136 configured to provide for occupant interaction with the vehicle 102. For instance, the computing platform 104 may interface with one or more buttons or other HMI controls configured to invoke computing platform 104 functions (e.g., steering wheel audio buttons, a push-to-talk button, instrument panel controls, etc.). The computing platform 104 may also drive or otherwise communicate with one or more displays 138 configured to provide visual output to vehicle occupants by way of a video controller 140. In some cases, the display 138 may be a touch screen further configured to receive user touch input via the video controller 140, while in other cases the display 138 may be a display only, without touch input capabilities.

The computing platform 104 may be further configured to communicate with other components of the vehicle 102 via one or more in-vehicle networks 142. The in-vehicle networks 142 may include one or more of a vehicle controller area network (CAN), an Ethernet network, and a media oriented system transfer (MOST), as some examples. The in-vehicle networks 142 may allow the computing platform 104 to communicate with other vehicle 102 systems, such as an vehicle modem 144 (which may not be present in some configurations), a global positioning system (GPS) module 146 configured to provide current vehicle 102 location and heading information, and various vehicle ECUs (Electronic Control Units) 148 configured to provide other types of information regarding the systems of the vehicle 102. As some non-limiting possibilities, the vehicle ECUs 148 may include a powertrain controller configured to provide control of engine operating components (e.g., idle control components, fuel delivery components, emissions control components, etc.) and monitoring of engine operating components (e.g., status of engine diagnostic codes); a body controller configured to manage various power control functions such as exterior lighting, interior lighting, keyless entry, remote start, and point of access status verification (e.g., closure status of the hood, doors and/or trunk of the vehicle 102); a radio transceiver configured to communicate with key fobs or other local vehicle 102 devices; and a climate control management controller configured to provide control and monitoring of heating and cooling system components (e.g., compressor clutch and blower fan control, temperature sensor information, etc.).

As shown, the audio module 122 and the HMI controls 136 may communicate with the computing platform 104 over a first in-vehicle network 142A, and the vehicle modem 144, GPS module 146, and vehicle ECUs 148 may communicate with the computing platform 104 over a second in-vehicle network 142B. In other examples, the computing platform 104 may be connected to more or fewer in-vehicle networks 142. Additionally or alternately, one or more HMI controls 136 or other components may be connected to the computing platform 104 via different in-vehicle networks 142 than shown, or directly without connection to an in-vehicle network 142.

The computing platform 104 may also be configured to communicate with mobile devices 152 of the vehicle occupants. The mobile devices 152 may be any of various types of portable computing device, such as cellular phones, tablet computers, smart watches, laptop computers, portable music players, or other devices capable of communication with the computing platform 104. In many examples, the computing platform 104 may include a wireless transceiver 150 (e.g., a BLUETOOTH module, a ZIGBEE transceiver, a Wi-Fi transceiver, etc.) configured to communicate with a compatible wireless transceiver 154 of the mobile device 152. Additionally or alternately, the computing platform 104 may communicate with the mobile device 152 over a wired connection, such as via a USB connection between the mobile device 152 and the USB subsystem 132.

The wide-area network 156 may provide communications services, such as packet-switched network services (e.g., Internet access, VoIP communication services), to devices connected to the wide-area network 156. An example of a wide-area network 156 may include a cellular telephone network. Mobile devices 152 may provide network connectivity to the wide-area network 156 via a device modem 158 of the mobile device 152. To facilitate the communications over the wide-area network 156, mobile devices 152 may be associated with unique device identifiers (e.g., mobile device numbers (MDNs), Internet protocol (IP) addresses, mobile station international subscriber directory numbers (MSISDNs), international mobile subscriber identity (IMSI), etc.) to identify the communications of the mobile devices 152 over the wide-area network 156. In some cases, occupants of the vehicle 102 or devices having permission to connect to the computing platform 104 may be identified by the computing platform 104 according to paired device data 160 maintained in the storage medium 112. The paired device data 160 may indicate, for example, the unique device identifiers of mobile devices 152 previously paired with the computing platform 104 of the vehicle 102, secret information shared between the paired device and the computing platform 104 such as link keys, and/or personal identification numbers (PINs), and most recently used or device priority information, such that the computing platform 104 may automatically reconnect to the mobile devices 152 matching data in the paired device data 160 without user intervention. In some cases, the paired device data 160 may also indicate additional or options related to the permissions or functionality of the computing platform 104 that the paired mobile device 152 is authorized to access when connected.

When a paired mobile device 152 that supports network connectivity is automatically or manually connected to the computing platform 104, the mobile device 152 may allow the computing platform 104 to use the network connectivity of the device modem 158 to communicate over the wide-area network 156. In one example, the computing platform 104 may utilize a data-over-voice connection over a voice call or a data connection of the mobile device 152 to communicate information between the computing platform 104 and the wide-area network 156. Additionally or alternately, the computing platform 104 may utilize the vehicle modem 144 to communicate information between the computing platform 104 and the wide-area network 156, without use of the communications facilities of the mobile device 152.

Similar to the computing platform 104, the mobile device 152 may include one or more processors 164 configured to execute instructions of mobile applications 170 loaded to a memory 166 of the mobile device 152 from storage medium 168 of the mobile device 152. In some examples, the mobile applications 170 may be configured to communicate with the computing platform 104 or other locally-networked devices and with the wide-area network 156.

The computing platform 104 may also include a device link interface 172 to facilitate the integration of functionality of the mobile applications 170 into the grammar of commands available via the voice interface 134. The device link interface 172 may also provide the mobile applications 170 with access to vehicle features, such as information available to the computing platform 104 via the in-vehicle networks 142 or access to the display 138. An example of a device link interface 172 may be the Ford APPLINK(R) component of the SYNC system provided by The Ford Motor Company of Dearborn, Mich. APPLINK(R) is based on the SDL technology platform, which allows APPLINK(R) to communicate between applications 170 executed by the mobile device 152 and the computing platform 104 of the vehicle 102.

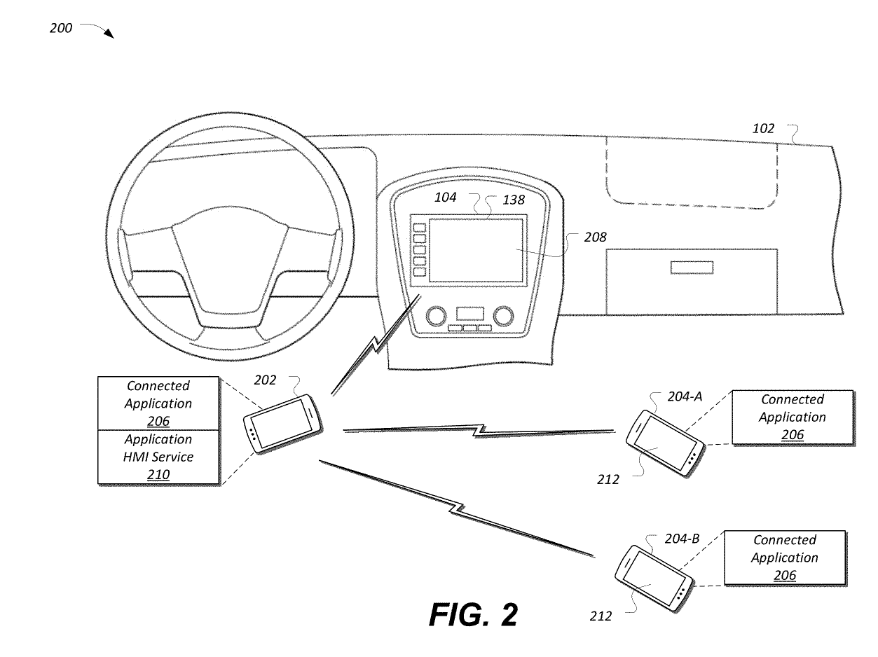

FIG. 2 illustrates an example diagram 200 of a portion of the system 100 configured for control of a connected application 206 installed to a primary-connected device 202 from one or more secondary-connected devices 204. As illustrated, the vehicle 102 includes the display 138 mounted in a HMI control area between the driver and front passenger seats. A primary-connected device 202 is connected to the computing platform 104, and secondary-connected devices 204-A and 204-B (collectively 204) are connected to the primary-connected device 202. The primary-connected device 202 exposes an application HMI service 210 that manages the connections of the secondary-connected devices 204 to the primary-connected device 202. The connected application 206 is installed to the primary-connected device 202 and also to each of the secondary-connected devices 204. The connected application 206 installed to the primary-connected device 202 may be controlled using the HMI of the vehicle 102, such as the display 138. Moreover, using the connected application 206, the secondary-connected devices 204 communicate with the primary-connected device 202 to control the instance of the connected application 206 of the primary-connected device 202 connected to the computing platform 104. It should be noted that the illustrated configuration is merely an example, and systems 100 having more or fewer secondary-connected devices 204 or varied device layouts are possible.

The primary-connected device 202 may be a mobile device 152 connected to the computing platform 104 as the primary device. As an example, the primary-connected device 202 may be designated as being a favorite device in the paired device data 160, such that the computing platform 104 may automatically reconnect to the primary-connected device 202 as the primary-connected device 202 when the primary-connected device 202 is identified by the wireless transceiver 150 as being within the vehicle 102. As another example, the primary-connected device 202 may be designated in the paired device data 160 as being a highest priority device compared to other located devices within the vehicle 102, such that the computing platform 104 may automatically reconnect to the primary-connected device 202 as the primary-connected device 202. As yet a further example, the primary-connected device 202 may be the first device identified in the paired device data 160 that is located within the vehicle 102 (or a random one of the devices).

The secondary-connected devices 204 may include other mobile devices 152 connected to the computing platform 104 but that are not connected as the primary device. As an example, the secondary-connected device 204 may include devices having entries in the paired device data 160 that are not the favorite or highest priority device. Or, as the secondary-connected devices 204 do not necessarily connect to the computing platform 104, the secondary-connected devices 204 may include mobile devices 152 that have not been paired with the computing platform 104 of the vehicle 102.

The connected application 206 may be installed to the primary-connected device 202. When executed by the primary-connected device 202, the connected application 206 may be able to utilize the features of the computing platform 104. For instance the connected application 206 may be configured to provide a user interface 208 to the display 138 of the computing platform 104. The user interface 208 may allow for a user to receive visual output from the connected application 206 and/or provide input to the connected application 206. In another example, the connected application 206 may be an audio streaming application, and may utilize the audio playback functionality of the audio module 122 to stream audio content from a server connected to the wide-area network 156 for playback.

The computing platform 104 may be configured to discover the applications installed to the primary-connected device 202 that are compatible with display on the vehicle HMI, and may provide a listing of the available applications to the display 138. A user may accordingly be able to activate an application, such as the connected application 206, based on selection from the listing, e.g., via input to the display 138 or via voice input to the voice interface 134.

The application HMI service 210 may be a service provided by the primary-connected device 202 to allow the secondary-connected devices 204 to control the connected application 206 executed by the primary-connected device 202. To allow the secondary-connected devices 204 to identify which of the mobile devices 152 is the primary-connected device, the application HMI service 210 may be configured to advertise itself when the primary-connected device 202 is connected to the computing platform 104 as the primary device. In some examples, the primary-connected device 202 may advertise the availability of the application HMI service 210 via Bluetooth or over Bluetooth Low Energy. As another possibility, the availability of the application HMI service 210 may be indicated over Wi-Fi, e.g., using WebSockets. Thus, the application HMI service 210 may indicate to the secondary-connected devices 204 that the primary-connected device 202 is the device connected to the computing platform 104.

The connected application 206 may also be installed to the secondary-connected devices 204. When executed by the secondary-connected devices 204, the connected application 206 may determine that it is not executed by the primary-connected device 202, and may attempt to locate an advertisement of the application HMI service 210. When the secondary-connected devices 204 locates and connects to the application HMI service 210, the connected application 206 may use the application HMI service 210 to provide an auxiliary user interface 212 to the display of the secondary-connected device 204. For example, the application HMI service 210 may be configured to accept messaging similar to that of the connected application 206 to the computing platform 104, such that the connected application 206 executed by the secondary-connected devices 204 may perform the same messaging to the primary-connected device 202 as the secondary-connected device 204 would perform when connected to the computing platform 104 as the primary device.

The auxiliary user interface 212 may also allow for a user to receive visual output from the connected application 206 and/or provide input to the connected application 206. To do so, when executed by the secondary-connected devices 204, the connected application 206 may communicate with the application HMI service 210 of the primary-connected device 202 to provide for auxiliary control of the connected application 206 of the primary-connected device 202. Thus, a user of one of the secondary-connected devices 204 may utilize the auxiliary user interface 212 provided by the connected application 206 in communication with the application HMI service 210 to monitor and/or control the functionality of the connected application 206 of the primary-connected device 202, despite the user being unable to reach the display 138 of the computing platform 104.

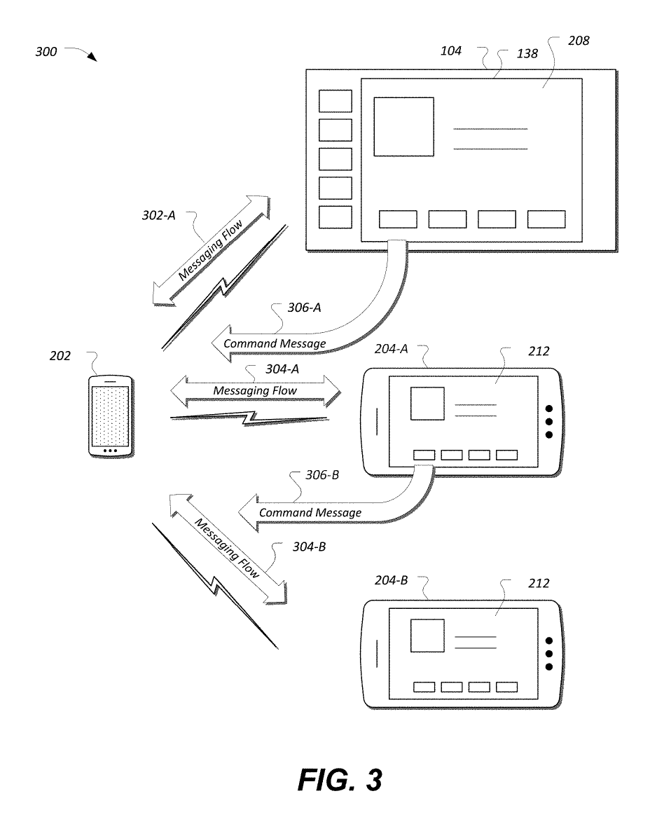

FIG. 3 illustrates an example diagram 300 of user interface messaging between the primary-connected device 202, the secondary-connected devices 204, and the vehicle computing platform 104. As shown, a primary messaging flow 302 may be provided between the application HMI service 210 of the primary-connected device 202 and the computing platform 104. Additionally, secondary messaging flows 304-A and 304-B may be provided between the application HMI service 210 of the primary-connected device 202 and the secondary-connected devices 204-A and 204-B, respectively. It should be noted that this configuration is merely an example, and systems having more or fewer secondary-connected devices 204 or varied device layouts are possible. However, it should be noted that in many examples each secondary-connected device 204 providing the auxiliary user interface 212 may utilize a separate secondary messaging flow 304.

The messaging flow 302 may include data communications configured to facilitate providing user interfaces to devices connected to the primary-connected device 202, such as the computing platform 104 and the secondary-connected devices 204. In an example, the messaging flow 302-A may be used in the providing of the user interface 208 to the computing platform 104 from the primary-connected device 202. For instance, the messaging flow 302 may include SDL messaging or other device link profile messaging provided by the connected application 206 to the computing platform 104. To use DSL as one example, the SDL messaging may include remote procedure call (RPC) messages and human-machine interface (HMI) messages. The RPC messages may include SDL messaging as sent between the primary-connected device 202 and the computing platform 104 in single-connected device situations. These messages may include, for example, commands sent in response to the user selection a control or requesting that a command be performed. The HMI messages may include messaging for management of the HMI typically sent between the core component of the device link interface 172 and the HMI of the vehicle 102 in single-connected device situations. These messages may include other information related to the generation of the HMI, such as updated data to be included in controls, not responsive to user command input.

The secondary messaging flows 304-A and 304-B may contain the same messaging information as included in the messaging flow 302, but may be used in providing the auxiliary user interface 212 to the secondary-connected devices 204-A and 204-B, respectively, from the primary-connected device 202. The Thus, the secondary-connected devices 204 may receive the secondary messaging 304 over respective connections to the primary-connected device 202, and may display the auxiliary user interface 212 on the display of the secondary-connected device 204. For example, when executed by the secondary-connected device 204, the connected application 206 may send a message to the primary-connected device 202 requesting for the primary-connected device 202 to provide the secondary messaging 304 for generation of the auxiliary user interface 212. Responsive to receipt of the request, the primary-connected device 202 may determine whether the secondary-connected device 204 is authorized to receive the auxiliary user interface 212, and, if so, may begin sending the secondary messaging 304. The user of the secondary-connected device 204 may accordingly be able to use the secondary-connected device 204 as an auxiliary view of the connected application 206 being executed by the primary-connected device 202. By using the secondary messaging flow 304 provided from the primary-connected device 202, similar to the primary message flow 302 provided to the computing platform 104, the auxiliary user interface 212 may accordingly include content corresponding to the user interface 208.

A user of the computing platform 104 may provide user input to the connected application 206 being executed by the primary-connected device 202. For instance, the user may provide input to the display 138, such as by pressing a button or other control of the user interface 208. Responsive to the input, the computing platform 104 may send a command message 306 (e.g., illustrated as command message 306-A) to the primary-connected device 202 over the connection between the computing platform 104 and the primary-connected device 202.

The command message 306-A may include information to be sent from the computing platform 104 to the primary-connected device 202 to inform the primary-connected device 202 of the user input to the display 138. In an example, the command message 306 may include an indication of a user interface control that was selected by the user (e.g., an SDL command message, a device link profile message of another protocol, etc.). The primary-connected device 202 may receive the command message 306-A and may process the operation by the connected application 206.

Responsive to the command message 306, the connected application 206 of the primary-connected device 202 may send messaging over the message flow 302-A to cause the computing platform 104 to update the displayed user interface 208. The connected application 206 of the primary-connected device 202 may also provide messaging over the message flows 304-A and 304-B, to the secondary-connected devices 204-A and 204-B, respectively, to cause the connected applications 206 executed by the secondary-connected devices 204 to correspondingly update the auxiliary user interfaces 212.

Additionally or alternately, a user of one of the secondary-connected devices 204 may provide user input to the connected application 206 being executed by the primary-connected device 202. In an example, a user may provide input to the display of the secondary-connected device 204-A, such as by pressing a button or other control of the auxiliary user interface 212 provided by the connected application 206. Responsive to the input, the connected application 206 may send a command message 306 (illustrated as command message 306-B) to the primary-connected device 202 over the connection between the secondary-connected device 204 and the primary-connected device 202.

The primary-connected device 202 may receive the command message 306-B, and may send messaging over the message flow 302-A to cause the computing platform 104 to update the displayed user interface 208. The connected application 206 of the primary-connected device 202 may also provide messaging over the message flows 304-A and 304-B, to the secondary-connected devices 204-A and 204-B, respectively, to cause the connected applications 206 executed by the secondary-connected devices 204 to correspondingly update the auxiliary user interfaces 212.

Thus, the connected application 206 of the primary-connected device 202 may be controlled by user input is provided to the user interface 208 of the computing platform 104, and/or by user input to the user interface 212 of one or more of the secondary-connected devices 204.

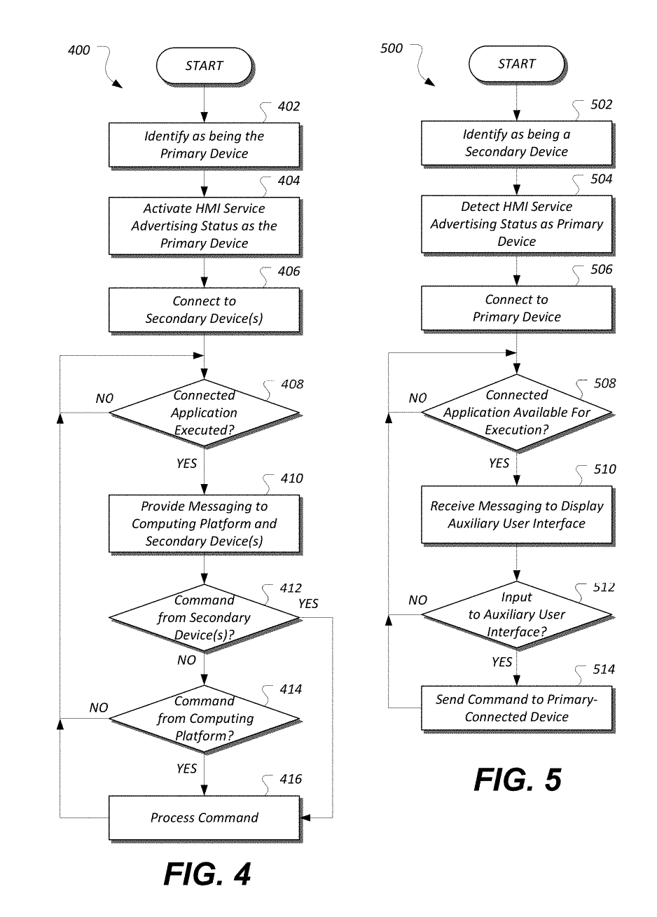

FIG. 4 illustrates an example process 400 for a mobile device 152 acting as a primary-connected device 202 in communication with the computing platform 104. At operation 402, the primary-connected device 202 identifies as being connected to the computing platform 104 as the primary device. For example, the computing platform 104 may access the paired device data 160 to determine which device should be paired as the primary device. For instance, the primary-connected device 202 may be designated as being a favorite device in the paired device data 160. As another example, the primary-connected device 202 may be designated in the paired device data 160 as being a highest priority device compared to other located devices within the vehicle 102. As yet a further example, the primary-connected device 202 may be the first device identified in the paired device data 160 that is located within the vehicle 102 or the device out of the available devices that was most recently paired to the computing platform 104 as the primary-connected device 202. The primary-connected device 202 may accordingly be informed of the determination, and may connect to the computing platform 104 as the primary device.

At operation 404, the primary-connected device 202 activates the application HMI service 210. In an example, to allow secondary-connected devices 204 to identify which of the mobile devices 152 is the primary-connected device 202, the application HMI service 210 may be configured to advertise itself when the primary-connected device 202 is connected to the computing platform 104 as the primary device.

At operation 406, the primary-connected device 202 connects to one or more secondary-connected devices 204. In an example the secondary-connected devices 204 may locate and connect to the application HMI service 210.

At operation 408, the primary-connected device 202 determines whether a connected application 206 is being executed by the primary-connected device 202. In an example, the primary-connected device 202 determines whether a connected application 206 is currently providing a user interface 208 to the display 138 of the computing platform 104. If so, control passes to operation 410. Otherwise control remains at operation 408.

At operation 410, the primary-connected device 202 provides messaging to the computing platform 104 and to the secondary-connected devices 204. In an example, the primary-connected device 202 may send a primary messaging flow 302 to the computing platform 104 and secondary messaging flows 304 to each of the one or more secondary-connected devices 204. For instance, the messaging flows 302 and 304 may include SDL messaging or other device link profile messaging provided by the connected application 206 of the primary-connected device 202 to the computing platform 104 and the one or more secondary-connected devices 204.

At operation 412, the primary-connected device 202 determines whether a command message 306 is received from one of the secondary-connected devices 204. In an example, a user may provide input to the display of the secondary-connected device 204-A, such as by pressing a button or other control of the auxiliary user interface 214 provided by an instance of the connected application 206 executed by the secondary-connected device 204-A. Responsive to the input, the connected application 206 of the secondary-connected device 204-A may send a command message 306 to the primary-connected device 202 over the connection between the secondary-connected device 204 and the primary-connected device 202. The primary-connected device 202 may accordingly receive the command message 306.

At operation 414, the primary-connected device 202 determines whether a command message 306 is received from the computing platform 104. In an example, a user may provide input to the display 138, such as by pressing a button or other control of the user interface 208 of the connected application 206. Responsive to the input, the computing platform 104 may send a command message 306 to the primary-connected device 202 over the connection between the computing platform 104 and the primary-connected device 202. The primary-connected device 202 may accordingly receive the command message 306.

At operation 416, the computing platform 104 performs the command specified by the command message 306. Thus, the input from the computing platform 104 or the secondary-connected device 204 may be used to control the operation of the commented application 206 executed by the primary-connected device 202. After operation 416, control passes to operation 408.

FIG. 5 illustrates an example process 500 for a mobile device 152 acting as a secondary-connected device 204 in communication with the primary-connected device 202.

At operation 502, the mobile device 152 identifies as being a secondary-connected device 204. For example, similar to as discussed above with respect to operation 402, the computing platform 104 may access the paired device data 160 to determine which device should be paired as the primary device. The mobile device 152 may accordingly be informed of the determination. However, in contrast to operation 402, at operation 502 the mobile device 152 may be identified as not being the primary device.

At operation 504, the secondary-connected device 204 detects the application HMI service 210. In an example, the secondary-connected device 204 identifies the application HMI service 210 activated at operation 404.

At operation 506, the secondary-connected device 204 connects to the primary-connected device 202. Similar to as discussed above with respect to operation 406, the secondary-connected device 204 connects to the primary-connected device 202.

At operation 508, the secondary-connected device 204 determines whether a connected application 206 available on the secondary-connected device 204 is being executed by the primary-connected device 202. If so, the secondary-connected device 204 may activate an instance of the connected application 206 installed to the secondary-connected device 204. Variations on the operation 508 are possible. As another example, as the secondary-connected device 204 may display HMI from the primary-connected device 202, the secondary-connected device 204 may utilize a generic client application having SDL or other device link profile messaging functionality to connect to the primary-connected device 202 rather than the same connected application 206. As yet a further example, the secondary-connected device 204 may utilize a different client application installed to secondary-connected device 204 having SDL messaging or other device link profile messaging capabilities.

At operation 510, the secondary-connected device 204 receives a messaging flow 304 from the primary-connected device 202 to display the auxiliary user interface 212. In an example, and similar to as discussed above with respect to operation 410, the primary-connected device 202 may send secondary messaging flows 304 to each of the one or more secondary-connected devices 204. For instance, the messaging flows 304 may include SDL messaging or other device link profile messaging provided by the connected application 206 of the primary-connected device 202 to the one or more secondary-connected devices 204.

At operation 512, the secondary-connected device 204 determines whether input is received. In an example, the connected application 206 executed by the secondary-connected device 204 may determine whether user input is received to the auxiliary user interface 212 being provided to the display of the secondary-connected device 204. If input is detected, control passes to operation 514. Otherwise, control passes to operation 508.

At operation 514, the secondary-connected device 204 sends the command input to the primary-connected device 202. In an example, responsive to the input to the user interface 212, the secondary-connected device 204 may generate the command message 306, and may send the command message 306 to the primary-connected device 202 over the connection between the secondary-connected device 204 and the primary-connected device 202. The primary-connected device 202 may receive the command message 306 and may process the command. After operation 514, control passes to operation 508.

Computing devices described herein, such as the computing platform 104, mobile devices 152, primary-connected devices 202, and secondary-connected devices 204, generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, C#, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

With regard to the processes, systems, methods, heuristics, etc., described herein, it should be understood that, although the steps of such processes, etc., have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a primary mobile device programmed to:
advertise an application human-machine interface (HMI) service responsive to connection to a computing platform of a vehicle as the primary mobile device,
connect to at least one secondary mobile device, and
provide a user interface of a connected application executed by the primary mobile device to the computing platform and to the at least one secondary mobile device, each secondary mobile device executing the connected application.

2. The system of claim 1, wherein the primary mobile device is further programmed to provide messaging flows, formatted in a device link interface protocol configured to integrate functionality of the connected applications to the computing platform, to the computing platform and to the at least one secondary mobile device to cause the computing platform and the at least one secondary mobile device to each render the user interface.

3. The system of claim 2, wherein the messaging flows include remote procedure call messages responsive to command messages, and HMI messages to render the user interfaces.

4. The system of claim 2, wherein the device link interface protocol is SmartDeviceLink (SDL).

5. The system of claim 1, wherein the primary mobile device is further programmed to:
receive a command message from the computing platform; and
update the user interface of the computing platform and the at least one secondary mobile device responsive to the command message.

6. The system of claim 1, wherein the primary mobile device is further programmed to:
receive a command message from one of the at least one secondary mobile device; and
update the user interface of the computing platform and the at least one secondary mobile device responsive to the command message.

7. The system of claim 1, wherein the primary mobile device is a driver device.

8. A system comprising:
a plurality of mobile devices, each executing a connected application, one of the mobile devices connected to a vehicle computing platform as a primary device, each other mobile device connected to an application human-machine interface (HMI) service executed by the primary device, the primary device programmed to send message flows to the computing platform to provide a primary user interface and to each other mobile device to provide secondary user interfaces.

9. The system of claim 8, wherein the primary mobile device is further programmed to provide the messaging flows, formatted in a device link interface protocol configured to integrate functionality of the connected applications to the computing platform, to the computing platform and to the at least one secondary mobile device to cause the computing platform and the at least one secondary mobile device to each render the user interface.

10. The system of claim 8, wherein the messaging flows include remote procedure call messages responsive to command messages, and HMI messages to render the user interfaces.

11. The system of claim 8, wherein the messaging flows are formatted in SmartDeviceLink (SDL) protocol.

12. The system of claim 8, wherein the primary device is further programmed to:
receive a command message from the computing platform; and
update the primary user interface of the computing platform and the secondary user interfaces of the at least one secondary mobile device responsive to the command message.

13. The system of claim 8, wherein the primary device is further programmed to:
receive a command message from one of the plurality of mobile devices; and
update the primary user interface of the computing platform and the secondary user interfaces of the each other mobile device responsive to the command message.

14. The system of claim 8, wherein the primary device is a driver device.

15. A non-transitory computer-readable medium, comprising instructions that, when executed by a processor of a mobile device, cause the mobile device to:
advertise an application human-machine interface (HMI) service responsive to connection to a computing platform of a vehicle as the primary mobile device;
connect to at least one secondary mobile device; and
provide message flows via the HMI service of a connected application executed by the primary mobile device to the computing platform and to the at least one secondary mobile device, to cause the computing platform and the at least one secondary mobile device to render a user interface of the connected application.

16. The medium of claim 15, further comprising instructions that, when executed by the processor of the mobile device, causing the mobile device to provide the messaging flows formatted in SmartDeviceLink (SDL) protocol to the computing platform and to the at least one secondary mobile device.

17. The medium of claim 15, wherein the messaging flows include remote procedure call messages responsive to command messages, and HMI messages to render the user interfaces.

18. The medium of claim 15, further comprising instructions that, when executed by the processor of the mobile device, cause the mobile device to:
receive a command message from the computing platform; and
update the user interface of the computing platform and the at least one secondary mobile device responsive to the command message.

19. The medium of claim 15, further comprising instructions that, when executed by the processor of the mobile device, cause the mobile device to:
receive a command message from one of the at least one secondary mobile device; and
update the user interface of the computing platform and the at least one secondary mobile device responsive to the command message.

20. The medium of claim 15, wherein the primary mobile device is a driver device.
